(19) United States
(12) Patent Application Publication
(10) Pub. No.: US 2026/0300039 A1
(43) Pub. Date: Oct. 1, 2026

(54) Method and System for Controlling an Interrupt Lock of a CPU of A Vehicle Control Unit in a User Mode

(71) Applicant: Bayerische Motoren Werke Aktiengesellschaft, Muenchen (DE)

(72) Inventor: Reinhold EINBERGER, Olching (DE)

(21) Appl. No.: 19/629,058

(22) Filed: Mar. 26, 2026

(30) Foreign Application Priority Data
Mar. 27, 2025 (DE) 10 2025 112 028.5

(51) Int. Cl. G06F 9/52; G06F 13/24

(52) U.S. Cl. CPC G06F 9/526; G06F 13/24

(57) ABSTRACT

A method for controlling an interrupt lock of a CPU of a vehicle control unit in a user mode includes starting a predefined lockout time subject to a condition for controlling the interrupt lock in the user mode, in particular without switching to a supervisor mode that is hierarchically superior to the user mode, by writing a start bit to a lock-state register, whereby an interrupt deactivation signal is sent to an interrupt controller; executing an uninterrupted function by code executing in a code environment of the user mode during the interrupt lock bounded by the predefined, conditioned lockout time; and releasing the interrupt lock if the condition is met by the executing code before the lockout time elapses, and at the latest when the predefined lockout time subject to the condition has elapsed.

### CROSS REFERENCE TO RELATED APPLICATION

This application claims priority under 35 U.S.C. §119 from German Patent Application No. DE 10 2025 112 028.5, filed Mar. 27, 2025, the entire disclosure of which is herein expressly incorporated by reference.

### BACKGROUND AND SUMMARY

The disclosure relates to a method and a system for controlling an interrupt lock of a CPU of a vehicle control unit in a user mode

In modern computing systems, consistent processing of complex data is critical, especially when multiple processes or threads are accessing shared data simultaneously. To avoid data conflicts, a synchronization mechanism is often used to ensure that no unexpected changes are made to the data during a copy operation. A common method of securing such processes is to use atomic functions, optionally by using an interrupt lock. This disables the processing of interrupts during a critical section, so that the current copy operation can be completed undisturbed. The term atomic function as used here describes all functions for which an interrupt lock is provided during their execution.

In simple processor architectures, the interrupt lock can be set directly by clearing an enable bit, usually the 'IE' bit in the status register. This operation is efficient because it can be executed in few clock cycles and does not require any additional context changes. However, with the advancement of processor architectures and the introduction of complex rights management systems, direct access to the status register has been restricted for processes running in a lower rights group, such as the 'User' rights group. In such systems, setting and/or clearing the interrupt enable is only possible via special system services that must be performed by switching to a privileged mode, such as supervisor or hypervisor status.

However, calling such system services requires a number of additional operations, including backing up registers and performing a context switch, which results in a significant increase in runtime. This in turn increases the processor load and can negatively affect the overall performance of the system, in particular when frequent synchronization operations are performed. This problem poses a challenge for the development of efficient and secure synchronization mechanisms that both ensure tamper protection and have the least possible impact on system performance.

An object of the present disclosure is to provide an improved method and/or system in this respect.

This object is achieved by the subject matter disclosed herein. Advantageous configurations are also specified in the present disclosure.

The present disclosure relates to a method for controlling an interrupt lock of a CPU of a vehicle control unit in a user mode, comprising the steps: starting a predefined lockout time subject to a condition for controlling the interrupt lock in the user mode, in particular without switching to a supervisor mode that is hierarchically superior to the user mode, by writing a start bit to a lock-state register, whereby an interrupt deactivation signal is sent to an interrupt controller; continuing to execute the required uninterrupted function in the user mode during the interrupt lock bounded by the predefined, conditioned lockout time; and releasing the interrupt lock if the condition is met by the executing code before the lockout time elapses, and at the latest when the predefined lockout time subject to the condition has elapsed.

The present disclosure also comprises a system for controlling an interrupt lock of a CPU (computer processing unit) of a vehicle control unit in a user mode, comprising: the CPU, a lockout time counter, an interrupt controller and a lock-state register, wherein: the lockout-time counter is designed to start a predefined lockout time subject to a condition for controlling the interrupt lock in the user mode, in particular without switching to a supervisor mode that is hierarchically superior to the user mode, by writing a start bit to the lock-state register, whereby an interrupt deactivation signal is sent to an interrupt controller; the interrupt controller is designed to continue to execute the required non-interruptible function in the user mode during the interrupt lock bounded by the predefined, conditioned lockout time; and the lockout time counter is designed to release the interrupt lock if the condition is met by the executing code before the lockout time elapses, and at the latest when the predefined lockout time subject to the condition has elapsed. The CPU can also generally be understood as a processor or as a computing unit.

The statements made for the method apply mutatis mutandis to the system and vice versa.

The control of an interrupt lock of a CPU in a vehicle control unit is preferably carried out in the user mode in order to protect critical processes from interruptions. This control enables interrupts to be deactivated and released again after a defined period of time or after completion of an action, preferably without direct intervention in the supervisor mode.

A predefined lockout time is preferably started to ensure that interrupts remain blocked for no longer than a specified duration. This lockout time is linked to a condition, so that it can preferably be terminated either automatically after expiry or prematurely by an explicit instruction.

The user mode is preferably a non-privileged operating level of a CPU which is running software without direct access to critical system resources. This mode is designed to provide security by preventing unauthorized access to system registers and preferably allowing only restricted operations. Also, this code cannot prevent the execution of higher priority code and can be interrupted by it at any time.

The hierarchically superior supervisor mode is a privileged operating level of a CPU, which preferably allows full access to system registers and protected memory areas. In this mode, security-critical and hardware-related functions can be executed that are not permitted in user mode, preferably to ensure system integrity and tamper protection.

An interrupt controller is a hardware or software component that manages incoming interrupts and preferably processes them in a prioritized manner. It decides which interrupts are forwarded to the CPU and when, in order to ensure efficient and controlled interrupt processing, preferably without unnecessary delays.

An interrupt function is a specific task that is triggered by an interrupt in order preferably to perform time-critical operations independently of the main program. Examples include copying data between memory areas, acquiring sensor data or controlling communication interfaces, preferably to ensure a high system responsiveness.

An atomic function is preferably a specific task that is correctly performed only when executed without interruption by other code. This is preferably achieved by executing it within an interrupt handler, thus as an interrupt function or preferably by locking the interrupt, provided that the architecture permits this. Another term for such a function is “non-interruptible function”.

An interrupt handler is a software routine that is called when an interrupt occurs and preferably ensures fast and efficient processing. It can perform critical tasks, such as updating system states or controlling hardware, preferably without affecting the overall performance of the system.

An interrupt lock can preferably be lifted before the designated lockout period elapses if the protected operation has been completed. This optimizes the system response time, as accumulated interrupts can be processed earlier, preferably to avoid unnecessary delays.

Controlling the interrupt lock increases the real-time capability of the system by executing time-critical processes to be executed atomically, preferably without delays, in the user mode without the need for time-consuming switching to the higher-level supervisor mode. The fact that the interrupt lock is coupled to a lockout time means that the processor is preferably not blocked for an unnecessarily long time, allowing efficient use of system resources. The separation between user mode and supervisor mode ensures that only authorized code can make changes to critical system components, preferably to prevent unwanted tampering attempts. The ability to suspend the lock prematurely or automatically release it by a defined event optimizes the responsiveness of the system, preferably to avoid unnecessary waiting times.

The present disclosure operates with a predefined lockout time that is subject to a condition, so that it is not always necessary to wait for the lockout time to elapse. The present disclosure now offers a solution to the conflict between running time and security requirements. In this case, the program code at the user level (user mode) is also always allowed to set an interrupt lock. However, in this case, the interrupt lock is limited to a small time interval, so that the required security level in the overall system is still always satisfied. On the other hand, a maximum permissible delay of a pending interrupt request can preferably only be set to a minimum possible constant value by the supervisor code. Insofar as interruptions or interrupts are pending in the present case, these interrupts are preferably executed in the order of their priority, in particular when the user code is unlocked or a timeout or expiry of the predefined lockout time occurs.

An interrupt handler is preferably a software routine that is executed when an interrupt occurs. An interrupt is preferably a signal that causes the processor to interrupt the current program execution. The processor preferably stores the current state and jumps to the defined address of the interrupt handler. The handler preferably performs the necessary actions, such as reading in data, controlling hardware, or updating system states. After processing, the processor preferably restores the previous state and continues the interrupted program. Hardware interrupts come from devices such as a keyboard or hard disk, while software interrupts can be triggered by programs.

Once a block has been applied by setting an interrupt, the block can be released earlier by a program code if required, in particular if the interrupt is no longer needed, but at the latest when the set lockout time elapses. The lockout time cannot be reset once it is started. Resetting of the lockout time is only possible once the lockout time has elapsed or been cleared. This ensures that under no circumstances will the maximum allowed delay in the execution of a pending interrupt be exceeded by actions at the user level.

On this timeout and/or clearing, all interrupts that have accumulated up to that point are preferably processed before it is possible to set the lockout time once again using the original program code.

For example, even deliberately incorrectly programmed code cannot violate the defined maximum interrupt latency, resulting in improved security. As a result, among other advantages, there is no longer any need to prevent the “direct” locking of the interrupt in a user mode. Thus, in a “normal user mode”, an executed piece of program code can quickly request the interrupt lock via CPU command or via read/write access with few instructions, execute the non-interruptible action and release the interrupt again without having to make time-consuming context changes. This allows for fast and efficient control of the interrupts, preferably with only a few instructions. Direct control of the interrupt lock is preferably only possible by a small number of commands, which minimizes the response time. Access is preferably effected without switching to a privileged mode, which avoids additional administration overhead. The entire operation can preferably be completed without the system having to switch to a supervisor or hypervisor mode.

The maximum permissible interrupt lock, which may preferably include a start value of the lockout time, can preferably be written as an almost constant value in supervisor mode. This means that a “user mode” code does not need to be changed. With an appropriate CPU architecture, a separate CPU instruction can be defined for each of “int_disable_timed” and “int_enable_timed”. “int_disable_timed” is a function that disables interrupts for a specified period of time, preferably to protect critical sections of code from interruptions. It ensures that the interrupts are automatically reactivated after the defined time has elapsed, preferably without additional manual intervention. “int_enable_timed” is a function that automatically reactivates previously deactivated interrupts after a specified time interval, preferably to ensure a controlled recovery of normal interrupt processing. It ensures that time-critical processes remain uninterrupted, preferably without blocking the system for an unnecessarily long time.

In a further aspect it is proposed that a restart of the predefined lockout time subject to the condition is prevented while the lockout time is running and is possible only after the condition is met, or at the latest after the predefined lockout time has elapsed.

A restart of the predefined lockout time subject to a condition while it is running is preferably prevented, in order to ensure that the specified maximum lockout time is not unintentionally extended. A restart is only possible after the defined condition has been met or after the lockout time has elapsed, preferably in order to ensure predictable and controlled processing of interrupts. A control of this kind prevents an uncontrolled delay of interrupts and preferably ensures reliable compliance with real-time requirements. Limiting the lockout time increases system stability by avoiding an unwanted extension of the interruption, preferably to ensure uniform system performance.

A counter of the lockout time is started by preferably loading a timeout value for the lockout time. At startup, the interrupt deactivation signal to the interrupt controller is also preferably set. If the counter is stopped or the timeout is reached, the interrupt deactivation signal is preferably cleared.

In a further aspect it is proposed that the condition being met by the executing code before the lockout time elapses comprises clearing the start bit from the lock-state register by a write command of the executing code, whereby the predefined lockout time is paused and the interrupt lock is released.

If the executing code meets the condition before the lockout time elapses, this preferably causes the start bit to be cleared from the lock-state register. This clearing is effected by a write command of the executing code, which pauses the predefined lockout time and suspends the interrupt lock, preferably to allow the system to respond early. The lock-state register is a memory area that manages the current status of the interrupt lock and can preferably be changed by direct write accesses. The ability to suspend the lock at an early stage helps to reduce unnecessary delays and preferably enables greater efficiency in processing real-time events.

The interrupt controller preferably prevents execution of incoming interrupts as long as the disabled flag is set. When the lockout time is reset, all pending interrupts are preferably executed. Thus, each interrupt is defined by the value of the lockout time, and all other interrupts are executed immediately after the lockout time has elapsed or terminated prematurely, according to a predetermined prioritization.

In a further aspect it is proposed that processing of all interrupt lock requests accumulated during the predefined lockout time takes place after the condition is met, but at the latest when the predefined lockout time has elapsed.

The processing of all interrupt lock requests that have accumulated during the predefined lockout time is preferably carried out immediately after the condition has been met, or at the latest when the lockout time elapses. This control procedure ensures that all blocked interrupt requests are processed within a specified time frame, preferably to prevent an unlimited delaying of interrupts. Interrupt lock requests are requests from hardware or software interrupts that were not able to be processed during the lockout time and are preferably stored in a wait queue. This delay control improves the system response, since all accumulated interrupts are processed efficiently and in a predictable manner, preferably to ensure uniform system load distribution.

In a further aspect it is proposed that after the interrupt lock has been released, all accumulated interrupt lock requests are executed in prioritized order.

After the interrupt lock is released, all accumulated interrupt lock requests are preferably executed in prioritized order to ensure that critical interrupts are preferentially handled with high priority. The prioritizing of the interrupts is preferably handled by the interrupt controller, which uses predefined rules to determine which interrupts are processed first. An interrupt controller is a hardware or software unit that is responsible for managing interrupt signals and, preferably, ordering them by priority. This prioritized processing achieves efficient system utilization by handling particularly time-critical events in a preferential manner, preferably in order to ensure the best possible system response time.

In a further aspect it is proposed that upon an attempt to reset the predefined lockout time subject to the condition while the lockout time has already started, an error flag is set to signal an erroneous code sequence in the executing code in the user mode.

Writing the start bit of the lock-state register preferably starts a counter for the duration of the predefined lockout time. If the counter is already running, an error flag can be set to signal an error in the code sequence. The counter is then preferably not reloaded, but continues to count until the lockout time elapses.

In a further aspect it is proposed that the predefined lockout time subject to the condition is set in a supervisor mode by a supervisor level code to provide an adjustable latency time for an interrupt handler.

Preferably, the predefined lockout time subject to the condition is used to provide an adjustable latency time for the interrupt handler. The latency time determines the maximum period of time that interrupts remain blocked before they are processed, preferably in order to control the system response in a targeted manner. This lockout time is set by a supervisor level code, which is preferably executed in the privileged supervisor mode. Supervisor mode is a higher authorization level of the CPU, which allows protected system functions to be controlled, preferably to enable controlled management of security-critical processes. Supervisor level code is a special software routine that is preferably used for system administration tasks and allows direct access to hardware and protection mechanisms. This specific configuration allows the latency time of the interrupt processing to be adapted to specific operating conditions, preferably to ensure an optimized balance between real-time capability and process reliability. The possibility of individual adjustment ensures that the lockout time can be flexibly adapted to different system requirements, preferably in order to enable optimal resource utilization.

In a further aspect it is proposed that the predefined lockout time subject to the condition is optionally defined as a constant lockout time or dynamic lockout time which is dependent on operating conditions of a vehicle.

A timeout value of the lockout time can preferably be a constant, for example 1-2 µs. Alternatively, the timeout value of the lockout time can be set asynchronously by the supervisor level code. This allows different maximum response times to be specified depending on the operating conditions in the event of an error or, if sufficient, once only at system start-up.

In a further aspect it is proposed that in a supervisor mode, a supervisor code is used to check whether an event has occurred that relates to the predefined lockout time that is subject to the condition.

In supervisor mode, it is preferable to use a supervisor code to check a lockout time event in order to determine whether the predefined lockout time is active or has already elapsed. The supervisor mode is a privileged operating level of the CPU, which preferably allows access to security-critical and protected system areas. The supervisor code is a software routine specifically executed for this mode, which is preferably responsible for managing and monitoring system-relevant processes. A lockout time event describes a defined state of the lockout period, which is checked preferably to ensure the correct processing of interrupts. This check can be used to determine whether a lockout time must be kept active or terminated prematurely, preferably in order to enable efficient interrupt control. The use of the supervisor mode ensures that only authorized system routines can access these mechanisms, preferably to prevent manipulation by non-privileged processes.

In a further aspect it is proposed that the predefined lockout time subject to the condition can be configured with an adjustable lockout time value in a supervisor mode by a supervisor level code.

This requires switching to the supervisor mode to adjust the lockout time. Preferably, the lockout time cannot be adjusted in the user mode.

In another aspect, it is proposed that the interrupt controller comprises the prioritization and sequential processing of accumulated interrupts after the interrupt lock has been released.

Reference is made here to the statements relating to the corresponding method features, which also apply to the system in a corresponding manner.

In a further aspect, it is proposed that the system further comprises a memory-mapped control unit which is placed between an interrupt source and an interrupt input of the CPU, wherein the memory-mapped control unit is designed to write and/or read via lock-state registers and/or to perform the locking and/or release.

In some architectures, a memory mapped control unit can preferably be placed between interrupt sources and an interrupt input of the CPU, wherein the memory mapped control unit is designed to write and/or read via registers and/or to perform the locking and/or release.

During software development, the code can preferably read a flag state in user mode to check whether the interrupt lock has exceeded a maximum permissible time or whether an interrupt lock was invoked before the previous unlocking occurred. Reading is not necessary during the software development phase, but it is preferable if the interrupt function has a limited scope, for example when data to be copied has a limited (non-dynamic) size.

In addition, the supervisor code can check whether a timeout event of the lockout time has occurred. If this is intended, it can be associated with an interrupt event to obtain the most immediate response possible, or it may only be checked in a background task to create another form of error logging.

The calls to invoke the lockout time and/or the interrupt functions can preferably be implemented as a command instead of writing to registers, if supported by the CPU architecture. This allows the overhead time to be further reduced to a few nanoseconds.

The present disclosure also encompasses a computer program product, comprising instructions which, when the method is executed by a computer, cause the computer to execute the method.

The present disclosure also encompasses a computer-readable medium on which the computer program product is stored.

The present disclosure is preferably used in the field of vehicle software, but of course it is not limited to this field. The term vehicle refers to any system for transporting people and goods on roads, e.g. cars, trucks, buses, motorhomes, or motorbikes, on rails, on water or in the air. The vehicle can be powered by a combustion engine, hybrid drive or a pure electric drive.

In the light of the increasing importance of the RISC-V architecture, it is appropriate to introduce the present disclosure by a time-optimized solution, in particular by a dedicated CPU instruction. RISC-V is an open and license-free processor architecture that is preferably based on the reduced instruction set principle (RISC) and offers high modularity. It enables customizable hardware designs that can be optimized for a variety of applications from embedded systems to high-performance computers.

Furthermore, an analysis of existing ECU software code for vehicles using a debugger has shown a frequency of spin-lock calls with OS system call both before and after the consistent copying action. Several hundred calls per second occur in this operation and a context change took approximately 5 µs on the CPU under test. The actual copying action took less than 1 µs. A performance measurement showed that on average, approximately 2% of the CPU runtime was used for these context changes alone. It can also be verified by corresponding negative measurements.

Exemplary embodiments of the present disclosure are shown in the figures and will be explained in more detail in the following. Hereinafter, unless indicated otherwise, the same reference signs are used for identical and functionally identical elements.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a schematic flow diagram for an exemplary embodiment of the method,

FIG. 2 shows a schematic block diagram for an exemplary embodiment of the method, and

FIG. 3 shows a schematic block diagram of an example from the prior art for comparison with the present invention.

### DETAILED DESCRIPTION OF THE DRAWINGS

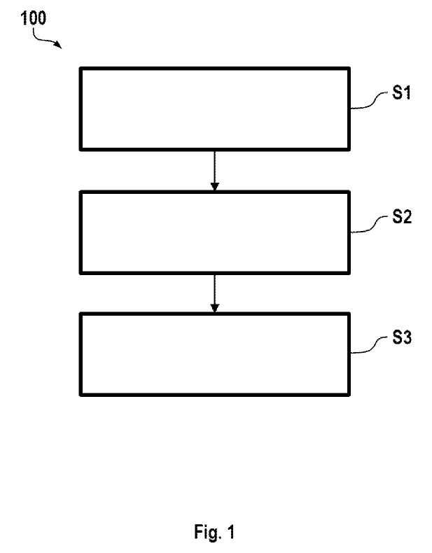

In FIG. 1, the method according to the present disclosure is shown in a first embodiment. The method for controlling an interrupt lock of a CPU of a vehicle control unit in a user mode comprises the following steps.

In a step S1, a predefined lockout time that is subject to a condition is started to control the interrupt lock in the user mode, in particular without switching to a supervisor mode that is hierarchically superior to the user mode, by writing a start bit to a lock-state register, whereby an interrupt deactivation signal is sent to an interrupt controller.

In a step S2, an atomic, non-interruptible function is executed in a code environment of the user mode during the interrupt lock bounded by the predefined, conditioned lockout time.

In a step S3 the interrupt lock is released if the condition is met by the executing code before the lockout time elapses, and at the latest when the predefined lockout time subject to the condition has elapsed.

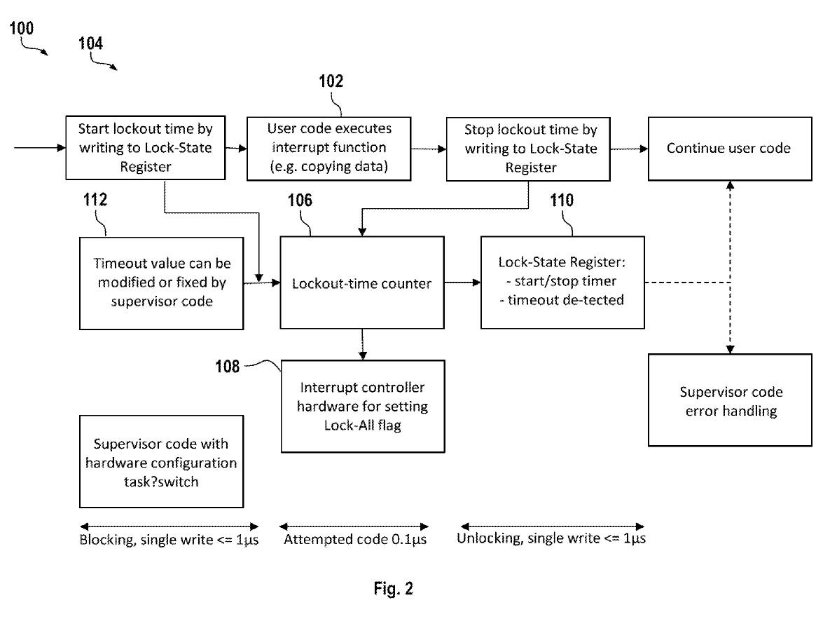

The method can be executed by a system 100. An example of such a system 100 is shown in FIG. 2. The system 100 is designed for controlling an atomic function 102 of a vehicle control unit 104 in a user mode. The system 100 comprises the CPU that performs function 102, a lockout time counter 106, an interrupt controller 108, and a lock-state register 110.

The lockout-time counter 106 is designed to start a predefined lockout time, subject to a condition, for controlling the interrupt lock in the user mode, in particular without switching to a supervisor mode that is hierarchically superior to the user mode, by writing a start bit to the lock-state register 110 by the CPU, whereby an interrupt deactivation signal is sent to an interrupt controller.

The interrupt controller 108 is designed to execute an interrupt function by an executing code of an interrupt handler in a code environment of the user mode during the interrupt lock bounded by the predefined, conditioned lockout time.

The lockout-time counter 106 is designed to release the interrupt lock if the condition is met by the executing code before the lockout time elapses, and at the latest when the predefined lockout time subject to the condition has elapsed. The timeout value of the lockout time can be changed or fixed by supervisor code 112. The lockout time is started by the CPU writing to the lock-state register 110 and stopped by rewriting to the lock-state register 110.

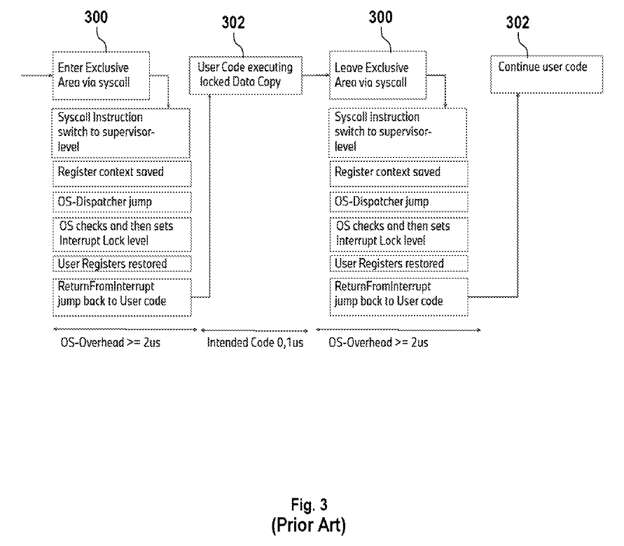

In FIG. 3, for comparison purposes, a method sequence from the prior art for setting interrupt locks is shown. In this case, to set the interrupt lock it is always necessary to switch to a user mode with interrupt lock 302 and then back to the user mode without interrupt lock, which requires switching briefly to the higher-level, exclusive supervisor mode 300 in both directions. This switching with duplication of step 300 is time-intensive, as is clear from the comparison with FIG. 2. In the comparative example of FIGS. 2 and 3, the previous runtime of around 4.5 microseconds (see FIG. 3), due to the double switching to the supervisor mode 300 and to the user mode 302 in between, is reduced to around 0.3 microseconds, since no switching is necessary in this case. Thus, with an existing vehicle control unit 104, approximately 5% of the total running time of the single CPU core is saved.

The features of the present disclosure described with reference to the embodiments illustrated may also be present in other embodiments of the present disclosure, unless otherwise indicated or, for technical reasons, intrinsically prohibited.

The foregoing disclosure has been set forth merely to illustrate the present disclosure and is not intended to be limiting. Since modifications of the disclosed embodiments incorporating the spirit and substance of the present disclosure may occur to persons skilled in the art, the invention should be construed to include everything within the scope of the appended claims and equivalents thereof.

### LIST OF REFERENCE SIGNS

100 system

102 executing user code with interrupt lock

104 vehicle control unit

106 lockout time counter

108 interrupt controller

110 lock-state register

112 supervisor code

300 supervisor mode

302 user mode

S1 method step of switching on interrupt lock

S2 method step of function in interrupt lock

S3 method step of switching off interrupt lock

What is claimed is:

1. A method for controlling an interrupt lock of a CPU of a vehicle control unit in a user mode, the method comprising:
starting a predefined lockout time that is subject to a condition for controlling the interrupt lock in the user mode without switching to a supervisor mode that is hierarchically superior to the user mode, by writing a start bit to a lock-state register, whereby an interrupt deactivation signal is sent to an interrupt controller;
executing an uninterrupted function by code executing in a code environment of the user mode during the interrupt lock bounded by the predefined, conditioned lockout time; and
releasing the interrupt lock in response to and at time when the condition is met by the executing code before the lockout time elapses, and at the latest, at a time when the predefined lockout time subject to the condition has elapsed.

2. The method according to claim 1,
wherein a restart of the predefined lockout time subject to the condition is prevented while the lockout time is running and is possible only after the condition is met, or at the latest after the predefined lockout time has elapsed.

3. The method according to claim 1,
wherein the condition being met by the executing code before the lockout time elapses comprises clearing the start bit from the lock-state register by a write command of the executing code, whereby the predefined lockout time is paused and the interrupt lock is released.

4. The method according to claim 1,
wherein processing of all interrupt requests accumulated during the predefined lockout time takes place after the condition is met, but at the latest when the predefined lockout time has elapsed, and
wherein, after the interrupt lock has been released, all accumulated interrupt requests are executed in prioritized order.

5. The method according to claim 1,
wherein upon an attempt to reset the predefined lockout time subject to the condition while the lockout time has already started, an error flag is set to signal an erroneous code sequence in the executing code in the user mode.

6. The method according to claim 1,
wherein in a supervisor mode, a supervisor code is used to check whether an event has occurred that relates to the predefined lockout time that is subject to the condition.

7. The method according to claim 1,
wherein the predefined lockout time subject to the condition is set in a supervisor mode by a supervisor level code to provide an adjustable latency time for an interrupt handler, and
wherein the predefined lockout time subject to the condition is optionally defined as a constant lockout time or dynamic lockout time which is dependent on operating conditions of a vehicle.

8. A system for controlling an interrupt lock of a CPU of a vehicle control unit in a user mode, comprising:
the CPU;
a lockout-time counter;
an interrupt controller; and
a lock-state register,
wherein the lockout-time counter is configured to start a predefined lockout time subject to a condition for controlling the interrupt lock in the user mode, without switching to a supervisor mode that is hierarchically superior to the user mode, by writing a start bit to the lock-state register, whereby an interrupt deactivation signal is sent to an interrupt controller,
wherein the interrupt controller is configured to execute a requested interrupt function by an executing code of an interrupt handler as soon as the interrupt lock is not present, and
wherein the lockout-time counter is configured to release the interrupt lock in response to the condition being met by the executing code before the lockout time elapses, and at the latest, when the predefined, conditioned lockout time has elapsed.

9. The system according to claim 8,
wherein the predefined lockout time subject to the condition is configured with an adjustable lockout time value in a supervisor mode by a supervisor level code.

10. The system according to claim 8,
wherein the interrupt controller comprisesprioritization and sequential processing of accumulated interrupts after the interrupt lock has been released.

11. The system according to claim 8,
wherein the system further comprises a memory-mapped control unit which is placed between an interrupt source and an interrupt input of the CPU, wherein the memory-mapped control unit is designed to write and/or read via lock-state register and/or to perform the locking and/or release.

12. A non-transitory computer-readable medium on which a computer program is stored, the computer program comprising instructions that, when executed by a computer, cause the computer to execute a method comprising:
starting a predefined lockout time that is subject to a condition for controlling an interrupt lock in a user mode without switching to a supervisor mode that is hierarchically superior to the user mode, by writing a start bit to a lock-state register, whereby an interrupt deactivation signal is sent to an interrupt controller;
executing an uninterrupted function by code executing in a code environment of the user mode during the interrupt lock bounded by the predefined, conditioned lockout time; and
releasing the interrupt lock in response to and at time when the condition is met by the executing code before the lockout time elapses, and at the latest, at a time when the predefined lockout time subject to the condition has elapsed.
